(19) United States
(12) Patent Application Publication
(10) Pub. No.: US 2004/0208644 A1
(43) Pub. Date: Oct. 21, 2004

(54) Sub-carrier generation for optical communication

(75) Inventors: Gabriel Sirat, Rehovot (IL); Daniel Neuhauser, Los-Angeles, CA (US); Yonathan Oren, Jerusalem (IL); Gadi Sarid, Tel Aviv (IL); Kalman Wilner, Ramat Gan (IL); Arik Bar Haim, Hertzlia (IL)

Correspondence Address: LADAS & PARRY, 26 WEST 61ST STREET, NEW YORK, NY, 10023, US

(73) Assignee: OPTICALIS LTD.

(21) Appl. No.: 10/153,556

(22) Filed: May 22, 2002

Related U.S. Application Data
(60) Provisional application No. 60/292,339, filed on May 22, 2001.
(60) Provisional application No. 60/330,819, filed on Oct. 31, 2001.
(60) Provisional application No. 60/363,591, filed on Mar. 11, 2002.

(51) Int. Cl. H04B 10/00; H04B 10/04

(52) U.S. Cl. 398/186

(57) ABSTRACT

An optical transmitter, consisting of a radiation source which is adapted to generate a base optical beam with a base wavelength. The transmitter further consists of at least one modulator which is coupled to modulate the base optical beam so as to generate multiple carrier beams at respective side-bands of the base wavelength and to introduce information into the carrier beams for transmission thereby to a receiver.

### CROSS-REFERENCE TO RELATED APPLICATIONS

This application claims the benefit of U.S. Provisional Patent Applications, 60/292,339 filed 22 May 2001, 60/330,819 filed 31 Oct. 2001, and 60/363,591 filed Mar. 11 2002, which are assigned to the assignee of the present invention and which are incorporated herein by reference.

### FIELD OF THE INVENTION

The present invention relates generally to data communication, and specifically to communicating data using optical carriers.

### BACKGROUND OF THE INVENTION

As data communications increase, the demand for bandwidth also increases; consequently, methods for increasing the bandwidth of data transfer systems are constantly being searched for. A data transfer system well known in the art uses optical radiation as a carrier, the carrier being modulated by a transmitter of the radiation and demodulated by a receiver of the radiation. Typically, the carrier is generated by a laser, although incoherent carriers are also used. Optical data transfer systems such as those described above typically transfer their radiation by a guiding medium such as an optical fiber, although optical systems which operate by over-the-air (i.e., substantially free space) transfer are known in the art.

One of the methods for increasing the bandwidth of an optical data transfer system is to use wavelength division multiplexing (WDM), wherein two or more carriers having distinct wavelengths are multiplexed and transmitted simultaneously through the guiding medium (or over-the-air). The carriers are demultiplexed at the receiver. Each carrier is separately modulated with data, so that in principle the effective bandwidth of the system increases according to the number of carriers used. Variations on WDM are known, for example in a dense WDM (DWDM) system separations between carriers are defined in terms of frequency, at present set at 100 GHz, although frequency separations of 50 GHz and 25 GHz are also proposed.

U.S. Pat. No. 4,703,474 to Foschini et al., whose disclosure is Incorporated herein by reference, describes a lightwave communication system using spread spectrum code division multiple access and WDM techniques for communication. The system uses a multiplicity of laser sources, each of which provides a carrier feeding into an optical fiber. The carrier wavelength may vary in a random fashion, but a receiver in the system tracks wavelengths of the carriers and is able to maintain good reception even If carriers overlap.

U.S. Pat. No. 5,414,552 to Godil, whose disclosure is incorporated herein by reference, describes a design for an optical modulator. Embodiments of the modulator are able to modulate light at frequencies in a range 2-75 GHz.

U.S. Pat. No. 5,550,666 to Zirngibl, whose disclosure is incorporated herein by reference, describes a wavelength division multiplexed multi-frequency optical source. The source comprises a plurality of optical amplifiers which operate between two parallel mirrors, forming an optical resonant cavity. The different optical amplifiers amplify different resonant modes of the cavity, wavelengths of the modes being substantially equally spaced, to provide different carriers which are then multiplexed in an optical fiber.

U.S. Pat. No. 5,627,668 to Fye, whose disclosure is incorporated herein by reference, discloses a laser diode that is modulated by a plurality of data channels that are carried on separate carrier frequencies. A frequency-selective optical amplifier conveys the modulated laser output via an optical fiber to a receiver, which demodulates the received signal using a narrow-band tunable filter and a photo-detector.

Production of side-bands by modulating a carrier with a modulation frequency is well known in the art. In the case of low levels of amplitude modulation of the carrier, an upper and a lower fundamental side-band, together with the original carrier, are produced, the side-bands being separated from the original frequency by the modulation frequency. If high levels of amplitude modulation are used, sufficient to cause non-linear modulation or “over-modulation,” side-bands separated by integer multiples of the modulation frequency may be produced. In the case of frequency or phase modulation, multiple side-bands that are separated from the carrier by multiples of the modulating frequency are produced. The number of side-bands and their levels are a function of the modulation frequency and of a modulation index, i.e., a ratio of the maximum frequency deviation caused by the modulation to the modulating frequency. In many situations, such as amplitude over-modulation or frequency or phase modulation, many of the side-bands are unwanted and may cause interference and/or distortion at a receiver.

Efficient use of WDM requires that wavelengths of carriers be relatively close together: wide spacing between carriers wastes bandwidth, and in addition, dispersion effects become more noticeable. Relatively close spacing of wavelengths in WDM systems may be achieved, at the cost of complicated and expensive systems which maintain the frequencies of the carriers substantially constant and finely separated. A simple system for generating multiple carriers for a WDM system is therefore required.

### SUMMARY OF THE INVENTION

It is an object of some aspects of the present invention to provide a method and apparatus for generating a plurality of optical carriers having distinct wavelengths.

It is a further aspect of some aspects of the present invention to provide a method and apparatus for maintaining separations between the optical carriers at substantially fixed values.

In preferred embodiments of the present invention, multiple, closely-spaced optical carriers for WDM-based communications are produced by modulating a single optical source beam at one or multiple frequencies. By contrast, methods of WDM known in the art use a separate laser source to generate each of the multiple wavelengths that they use. The use of a single source to generate multiple wavelengths reduces component costs and also allows closely-spaced carriers to be generated while maintaining accurate frequency spacing between the carriers.

In some preferred embodiments of the present invention, an optical beam from a single optical source is divided into a plurality of generally similar “sub-beams.” Preferably, the division is performed in a passive optical “star” splitter which receives the beam via a first optical fiber, and which conveys the sub-beams via respective second optical fibers. Each sub-beam is passed through a respective amplitude modulator, generating side-bands. Each modulator receives a different modulating frequency, and the output of each modulator is filtered to provide a separate, different, substantially single side-band wavelength for use as an optical carrier of data. Each carrier produced in this manner may be used substantially independently of the other carriers to convey data, by modulating the carrier. Thus, one single source is modulated to provide a plurality of separate carriers, the wavelength of each carrier being controlled by the frequency input to the modulator generating the carrier.

In some preferred embodiments of the present invention, more than one of the side-bands produced by one or more of the amplitude modulators are used as separate carriers. For example, an upper and a lower side-band, produced by a low level of amplitude modulation, may be separately extracted from the modulator, by filters, and each may be used as a carrier. If the level of amplitude modulation is increased, multiple upper and lower side-bands may be produced, and each may be used as a carrier. Each carrier may be modulated, so as to convey data, as described above.

Rather than first generating a carrier from the single source, and then modulating the carrier, the processes described above for conveying data may be implemented in a different order. For example, the data and its respective modulating frequency may first be mixed in a mixer. An output of the mixer is then used as a “modulating frequency” input to a specific amplitude modulator, which receives a sub-beam from the single source, as described above. An output of the amplitude modulator, filtered as necessary, is used as a carrier for conveying data.

In some preferred embodiments of the present invention, the beam from the single source is transferred directly to a modulator. Most preferably, the modulator is implemented to enable phase and/or frequency modulation, and may use one or more radio-frequency (RF) signals as modulating signals. The phase or frequency modulation produces multiple side-bands, and each side-band is isolated for use as a separate carrier. The level of modulation, and the frequency of each of the modulating signals, may be adjusted to set the frequencies and the levels of each of the side-bands. The levels of the side-bands are most preferably set to be approximately equal.

Preferably, the single source comprises a laser. Alternatively, the single source comprises a non-coherent source such as a relatively broadband light emitting diode (LED) whose output is filtered by a narrow-band filter. In some preferred embodiments of the present invention, two or more single sources are used for simultaneously and/or separately generating respective sets of side-bands which are used as data carriers.

After generation of the carriers and modulation of the carriers with data, as described above, the modulated carriers are preferably combined in a multiplexer and transmitted as a multiplexed beam to a receiver. The transmission may be via a guiding medium such as an optical fiber, or via an over-the-air system, or by a combination of these systems. The receiver de-multiplexes the multiplexed beam into the initial modulated carriers, and detects the data on each of the carriers.

Preferred embodiments of the present invention have a number of significant advantages:

A single source is used to generate the multiple carriers, thus avoiding the necessity of operating multiple sources.

Each single source may comprise a broadband source which is filtered by a narrow-band filter.

The carriers are defined electrically with respect to the single source, so that separation between the carriers is fixed.

A portion of the output of the single source, and/or a reference thereto, may be transmitted to the receiver for use as a signal from which the single source output may be recovered, if required.

Frequencies used to generate the carriers, and/or references to the frequencies, may also be transmitted to the receiver, facilitating duplication of the carriers at the receiver.

Because the carriers are generated electrically, addition or “dropping” of carriers is straightforward.

There is therefore provided, according to a preferred embodiment of the present invention, an optical transmitter, including:

a radiation source, which is adapted to generate a base optical beam with a base wavelength; and

at least one modulator, which is coupled to modulate the base optical beam so as to generate multiple carrier beams at respective side-bands of the base wavelength and to introduce information into the carrier beams for transmission thereby to a receiver.

Preferably, the radiation source includes a single laser source.

Alternatively or additionally, the radiation source includes a broadband source and a filter which filters an output of the broadband source to generate the base wavelength.

Preferably, the at least one modulator includes a side-band generator which is adapted to modulate the base optical beam by at least one modulation method chosen from a group of modulation methods consisting of amplitude modulation, frequency modulation, and phase modulation.

Preferably, the transmitter includes an optical component which is adapted to divide the multiple carrier beams into separate sub-beams.

Further preferably, the transmitter includes one or more radio-frequency (RF) generators which supply respective RF signals to the side-band generator, and preferably, respective levels of the one or more RF generators are adjusted so that levels of the side-bands are substantially equal one to another.

Preferably, the at least one modulator includes one or more components which separate the base optical beam into respective sub-beams, the one or more components consisting of at least one of an optical splitter and a filter.

Further preferably, the transmitter includes respective sub-beam modulators which modulate each of the sub-beams so as to generate the multiple carrier beams, each sub-beam modulator being adapted to modulate its respective sub-beam by at least one modulation method chosen from a group of modulation methods consisting of amplitude modulation, frequency modulation, and phase modulation.

Further preferably, the transmitter includes an RF generator, wherein at least one of the sub-beam modulators is adapted to receive the information and an RF signal from the RF generator and to generate its respective modulated sub-beam responsive to the information and the RF signal.

Preferably, the at least one modulator includes respective data modulators which modulate each of the carrier beams with the information, and wherein at least one of the data modulators is adapted to perform its modulation by at least one modulation method chosen from a group of modulation methods consisting of amplitude modulation, frequency modulation, phase modulation, and polarization modulation.

Preferably, the transmitter includes a multiplexer which combines each of the carrier beams including the introduced information into an output beam.

Preferably, the at least one modulator is coupled to introduce a reference into at least one of the carrier beams, the reference conveying at least one of a frequency of the base optical beam and a frequency of the multiple carrier beams.

There is further provided, according to a preferred embodiment of the present invention, an optical transmitter, including:

a plurality of radiation sources, each of which is adapted to generate a base optical beam with a different base wavelength; and

a plurality of modulators, each coupled respectively to one of the radiation sources, each of the modulators being coupled to modulate its respective base optical beam so as to generate respective multiple carrier beams at side-bands of the respective base wavelength and to introduce information into the carrier beams for transmission thereby to a receiver.

There is further provided, according to a preferred embodiment of the present invention, a method for optical communications, including:

generating a base optical beam at a base wavelength;

modulating the base optical beam so as to generate multiple carrier beams at respective side-bands of the base wavelength;

modulating the carrier beams with respective information signals; and

transmitting the modulated carrier beams to a receiver.

Preferably, generating the base optical beam includes generating the beam from a single laser source.

Alternatively or additionally, generating the base optical beam includes generating the beam from a broadband source and a filter which filters an output of the broadband source to generate the base wavelength.

Preferably, modulating the base optical beam includes modulating the beam by at least one modulation method chosen from a group of modulation methods comprising amplitude modulation, frequency modulation, and phase modulation.

Preferably, modulating the base optical beam includes dividing the multiple carrier beams into respective separate sub-beams.

Preferably, modulating the carrier beams includes performing the modulation by at least one modulation method chosen from a group of modulation methods consisting of amplitude modulation, frequency modulation, phase modulation, and polarization modulation.

Preferably, modulating the base optical beam includes modulating the beam with one or more radio-frequency (RF) signals, and preferably, modulating the beam with one or more radio-frequency (RF) signals includes adjusting respective levels of the one or more RF signals so that levels of the multiple carrier beams are substantially equal one to another.

The method preferably includes providing one or more components which separate the multiple carrier beams into respective sub-beams, the one or more components consisting of at least one of an optical splitter and a filter.

Preferably, modulating the base optical beam includes modulating each of the sub-beams by at least one modulation method chosen from a group of modulation methods comprising amplitude modulation, frequency modulation, and phase modulation.

Preferably, the method includes combining each of the modulated carrier beams into an output beam.

Preferably, the method includes introducing a reference signal into at least one of the carrier beams, the reference signal conveying at least one of a frequency of the base optical beam and a frequency of the multiple carrier beams.

Further preferably, the method includes:

separating each of the carriers at the receiver; and

demodulating each of the carriers so as to recover the respective information signals.

There is further provided, according to a preferred embodiment of the present invention, a method for generating a plurality of optical data carriers, including:

generating an optical beam having a base wavelength in a radiation source;

modulating the beam with at least one modulation frequency so as to generate a plurality of side-bands of the base wavelength; and

filtering the modulated beam so as to isolate each of the plurality of side-bands for use as an optical data carrier.

There is further provided, according to a preferred embodiment of the present invention, apparatus for generating optical data carriers, including:

a radiation source which is adapted to generate an optical beam having a base wavelength;

an optical modulator which is adapted to modulate the beam so as to generate side-bands of the base wavelength; and

an optical filter which is adapted to isolate each of the side-bands for use as an optical data carrier.

Preferably, the radiation source includes at least one source chosen from a group consisting of a laser and a filtered broadband source.

Further preferably, the optical modulator is coupled to perform the modulation by at least one method chosen from a group consisting of amplitude modulation, phase modulation, and frequency modulation.

There is further provided, according to a preferred embodiment of the present invention, a method for generating a plurality of optical data carriers, comprising:

generating an optical beam having a base wavelength;

dividing the beam into a plurality of sub-beams at the base wavelength; and

modulating each of the sub-beams with a different, respective modulation frequency so as to generate one or more side-bands from each of the sub-beams.

There is further provided, according to a preferred embodiment of the present invention, apparatus for generating optical data carriers, comprising:

a radiation source which is adapted to generate an optical beam having a base wavelength;

a splitter which is adapted to divide the beam into a plurality of sub-beams; and

a plurality of optical modulators each of which is adapted to receive a respective sub-beam and to modulate the sub-beam so as to generate one or more side-bands of the base wavelength.

There is further provided, according to a preferred embodiment of the present invention, a data receiver, including:

an input port which is adapted to receive a plurality of optical data carriers and a reference, the carriers having been generated by modulation of an optical beam having a base wavelength, each of the carriers being modulated by respective data, the reference characterizing at least one of a frequency of the base wavelength and the frequency of the modulation;

one or more filters which are adapted to separate each of the carriers responsive to the reference; and

a plurality of detectors each of which demodulates a respective carrier so as to recover the respective data present in the carrier.

There is further provided, according to a preferred embodiment of the present invention, an optical transmitter, including:

a radiation source, which is adapted to generate a base optical beam with a plurality of base wavelengths; and

at least one modulator, which is coupled to modulate the base optical beam so as to generate multiple carrier beams at respective side-bands of the plurality of base wavelengths and to introduce information into the carrier beams for transmission thereby to a receiver.

Preferably, the radiation source includes:

a plurality of sources each of which is adapted to generate a different one of the plurality of base wavelengths; and

a multiplexer which combines the plurality of base wavelengths into the base optical beam.

There is further provided, according to a preferred embodiment of the present invention, a method for optical communications, including:

generating a base optical beam with a plurality of base wavelengths;

modulating the base optical beam so as to generate multiple carrier beams at respective side-bands of the plurality of base wavelengths;

modulating the carrier beams with respective information signals; and

transmitting the modulated carrier beams to a receiver.

Preferably, generating the base optical beam includes:

generating each of the plurality of base wavelengths with a respective source; and combining the plurality of base wavelengths.

The present invention will be more fully understood from the following detailed description of the preferred embodiments thereof, taken together with the drawings, in which:

### BRIEF DESCRIPTION OF THE DRAWINGS

FIG. 1 is a schematic diagram of a multiple carrier generation system, according to a preferred embodiment of the present invention;

FIG. 2 is a schematic block diagram of a section of an alternative carrier generation system, according to a preferred embodiment of the present invention;

FIG. 3 is a schematic block diagram of a section of another alternative carrier generation system, according to a preferred embodiment of the present invention;

FIG. 4 is a schematic block diagram of a system for generating a modulated carrier, according to a preferred embodiment of the present invention;

FIG. 5 is schematic block diagram of a receiver, according to a preferred embodiment of the present invention;

FIG. 6 is a graph of relative power in a beam vs. frequency, for the beam output by the system of FIG. 1, according to a preferred embodiment of the present invention;

FIG. 7 is a graph of a frequency response of band-pass filters used in the receiver of FIG. 5, according to a preferred embodiment of the present invention;

FIG. 8 is a schematic block diagram of an alternative multiple carrier generation system, according to a preferred embodiment of the present invention;

FIG. 9 is a schematic block diagram of another multiple carrier generation system, according to a preferred embodiment of the present invention;

FIG. 10 is a schematic block diagram of an input section of a receiver, according to a preferred embodiment of the present invention; and

FIG. 11 is a graph of power output vs. frequency for a first arrangement of the system of FIG. 8, according to a preferred embodiment of the present invention;

FIG. 12 is a graph of power output vs. frequency for a second arrangement of the system of FIG. 8, according to a preferred embodiment of the present invention; and

FIG. 13 is a schematic block diagram illustrating a system for generating a base optical beam, according to an alternative preferred embodiment of the present invention.

### DETAILED DESCRIPTION OF PREFERRED EMBODIMENTS

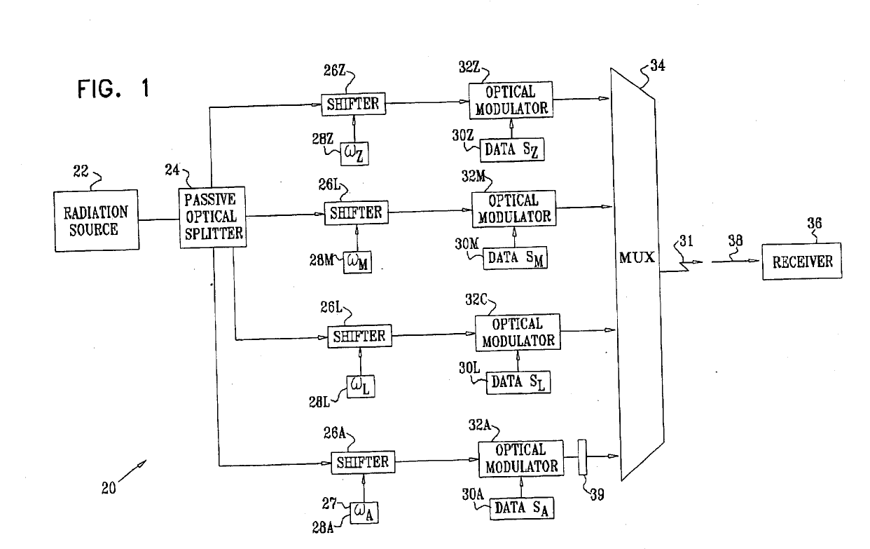

Reference is now made to FIG. 1, which is a schematic block diagram of a multiple carrier generation system 20, according to a preferred embodiment of the present invention. System 20 may be implemented from discrete optical and electronic elements, or from one or more compound elements, or from a combination of discrete and compound elements. Radiation transfer between elements of system 20 may be by any means known in the art, such as using optical fiber cable or optical components operating at least partly in a substantially free space environment.

Optical radiation from a radiation source 22 is transferred to an optical splitter 24, most preferably one or more passive optical splitters such as star splitters. Source 22 generates a base optical beam having a base wavelength. Preferably, source 22 comprises a laser, such as a solid-state laser. Alternatively, source 22 comprises an incoherent source such as a light emitting diode (LED), the output of which is filtered by a narrow-band filter to provide a substantially single wavelength. By way of example, source 22 is assumed to provide a free-space base wavelength of the order of 1.5 μm, corresponding to a frequency of 200 THz, but it will be appreciated that system 20 is able to operate at substantially any wavelength. Hereinbelow a frequency of source 22 is represented by q_{L}. An output of source 22 is represented as:

E=E₀ cos(q_{L}t) (1)

where E₀ is the amplitude of the output, and t is time.

Splitter 24 divides the radiation from source 22 into a plurality of generally similar single wavelength beams, and each beam is transferred to a respective substantially similar wavelength shifter 26A, . . . , 26Z. By way of example FIG. 1 illustrates four wavelength shifters 26A, 26L, 26M, and 26Z, but it will be understood that there is substantially no limit to the number of shifters which may be implemented in system 20. Each shifter acts as a side-band generator, as is described in more detail below. Hereinbelow wavelength shifters 26A, 26L, 26M, and 26Z, are also referred to generically as shifter 26. Each shifter 26 receives an input Eₙ=k₁E, where n is {A, . . . L,M, . . . Z}, and k₁ is a fraction between 0 and 1.

Each wavelength shifter 26 most preferably comprises any amplitude modulator known in the art, such as a Mach-Zehnder modulator or a Pockels or Kerr modulator, or any modulator using an electro-optic effect. Alternatively, each wavelength shifter comprises a single side-band frequency shifter, as is known in the art.

Each wavelength shifter 26A, 26L, 26M, and 26Z is coupled to receive a respective substantially single frequency ω_{A}, ω_{L}, ω_{M}, and ω_{Z}, from a respective frequency generator 28A, 28L, 28M, and 28Z. Hereinbelow frequency generators 28A, 28L, 28M, and 28Z, and their respective frequencies are also referred to generically as generator 28 and frequency ω. Each shifter 26 uses the respective frequency from its generator 28 to modulate its input Eₙ and generate at least one side-band from q_{L}, and the shifter most preferably comprises one or more narrow-band filters which substantially only allow a selected side-band to exit the shifter. The selected side-band is preferably an upper or a lower fundamental side-band, corresponding to a shift of frequency of ω from q_{L}, as is produced by low level amplitude modulation. Alternatively, the selected side-band may comprise a higher harmonic side-band, as is produced by higher level amplitude modulation, corresponding to a shift of nω from q_{L}, where n is an integer.

Further alternatively, one or more of shifters 26 comprises a harmonic generator 27, which generates a selected harmonic of frequency ω, nω, n≧2. Such generators are known in the art. For example, a Mach-Zehnder modulator produces different levels of harmonics, according to a level input to the modulator. The harmonic is then used to modulate q_{L} and generate a higher harmonic side-band, shifted from q_{L} by nω, which is isolated from carrier q_{L} and the other side-band by the one or more narrow-band filters in the shifter.

The output of each shifter 26, i.e., the shifted single frequencies q_{L}+nω_{A}, q_{L}+nω_{L}, q_{L}+nω_{M}, and q_{L}+nω_{Z}, are then used as a carrier which is modulated by data. Each carrier may be represented in general as:

E_{carrier}=k₁k₂E₀ cos((q_{L}+nω)t), (2)

where k₁ and k₂ are fractions between 0 and 1.

Each carrier is input to a respective optical modulator 32A, 32L, 32M, and 32Z, which respectively receive data streams S_{A}, S_{L}, S_{M}, and S_{Z}. The data streams are derived from respective data generators 30A, 30L, 30M, and 30Z. The data streams, optical modulators, and data streams are also herein respectively referred to generically as data stream S, optical modulator 32, and generator 30.

Each optical modulator 32 comprises any type of modulator which is able to modulate its input carrier q_{L}+nω with its input data stream S. Such optical modulators include, but are not limited to, Mach-Zehnder, Pockels, and Kerr modulators, and any modulator using an electro-optic effect. By way of example, each optical modulator 32 is assumed to operate as an amplitude modulator. The output of each modulator may be represented in general as:

Eₒᵤₜₚᵤₜ=S*E_{carrier} (3)

It will be appreciated, however, that each optical modulator may modulate its carrier by any modulation system known in the art, including, but not limited to, amplitude, keying systems such as frequency shift keying, frequency, phase, and/or polarization modulation systems, and combinations of these types of modulation.

The output of each modulator 32 is then most preferably combined by a multiplexer 34 into one wavelength division multiplexed (WDM) beam 31, which is then transmitted to a receiver 36. (A description of receiver 36 is given with reference to FIG. 5 below.) Alternatively, the output of at least some of modulators 32 is not combined in multiplexer 34, but may be transmitted “as is.” Multiplexer 34 may be any type of optical multiplexer known in the art, such as a Mach-Zehnder multiplexer or a passive power combiner. The output from multiplexer 34, which may be represented as ΣEₒᵤₜₚᵤₜ, is preferably transmitted to receiver 36 via an optical fiber cable 38. Alternatively or additionally, the output may be transmitted at least partly over-the-air. Optionally, one or more filters 39 are positioned after any specific modulator 32, for the purpose of enhancing selectivity of the output of the modulator. For example, filters 39 may filter out the carrier and one of the side-bands, producing a single side band (SSB) signal which is input to multiplexer 34. Alternatively, one of filters 39 may be implemented to filter out all side bands, producing a single channel at the frequency of the carrier.

It will be appreciated that each signal output by a respective modulator 34 has a very narrow frequency bandwidth, the bandwidth being a function of the bandwidths of the output of source 22, shifting frequency nω, and data S. The bandwidth is reduced by any filtration performed on the components of the signal, or on the output of modulator 34 by filters 39. Typically, the bandwidth is between approximately 1 GHz and approximately 10 GHz, and so dispersion effects in transmission of the signal (such effects occurring in a medium such as an optical fiber) are minimal.

Receiver 36 receives beam 31, and separates and/or de-multiplexes the signals by an optical method, such optical separation methods being well known in the art. Respective data S carried by each of the carriers is then recovered in a detector stage of receiver 36, to generate an electronic signal corresponding to S.

In some preferred embodiments of the present invention, a portion of the output E=E₀ cos(q_{L}t) of source 22, is incorporated in beam 31. The portion is preferably derived directly from the source, for example by receiving an output from splitter 24. Alternatively or additionally, the portion is at least partly generated by recovering an output representative of E from one of the outputs of a specific shifter 26 or a specific modulator 32, or by generating an output corresponding to E from another single wavelength source. Further alternatively, a reference to q_{L}, such as a sub-multiple of q_{L}, is incorporated into beam 31. It will be appreciated that receiver 36 is able to use the portion of E transmitted in beam 31, or the reference, in order to tune filters 33. Thus, any alteration in wavelength of source 22 may be compensated for at receiver 36.

Similarly, a reference for each shifting frequency ω may be transmitted to receiver 36 in beam 31, by any means known in the art. For example, a portion of an output from which ω is derivable may be taken from each shifter 26, and may be incorporated into beam 31. Alternatively or additionally, the reference may take the form of an indirect reference from which a specific value of ω is recoverable. For example, if a specific frequency generator 28 derives its output from a clock signal input to the generator, the clock signal, or a multiple or sub-multiple of the clock signal may be incorporated in beam 31 and transmitted to receiver 36. It will be appreciated that references described hereinabove may be used by receiver 36, by methods which are well known in the art, to accommodate any drift that may occur in the output of source 22 and/or of each shifter 26.

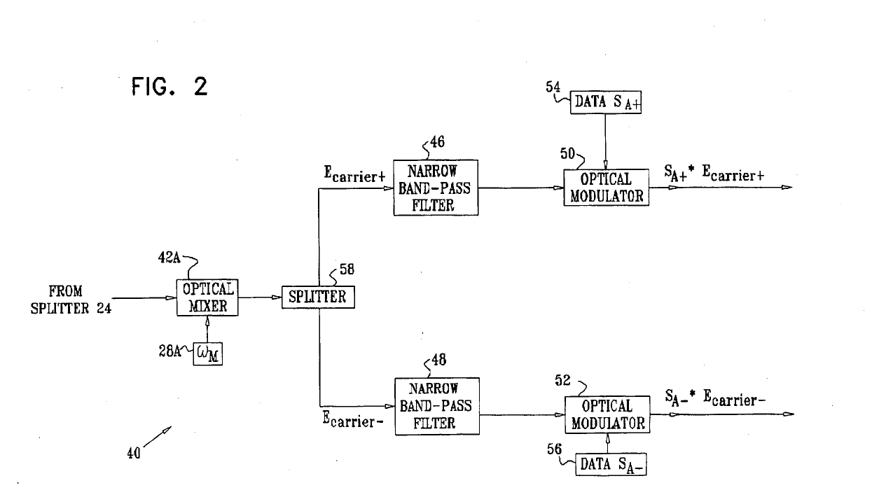

FIG. 2 is a schematic block diagram of a section 40 of an alternative carrier generation system, according to a preferred embodiment of the present invention. Section 40 replaces a shifter 26, and its related frequency generator 28, modulator 32, and data source 30 (FIG. 1). (Section 40 utilizes frequency generator 28 in a different arrangement from that of system 20.) By way of example, section 40 is assumed to replace shifter 26A, frequency generator 28A, modulator 32A, and data source 30A, but it will be understood that similar replacements may be made for other shifters 26, related frequency generators 28, modulators 32, and data sources 30. Apart from the differences described below, the operation and construction of elements of section 40 indicated by the same reference numerals as elements of system 20 (FIG. 1) are generally similar.

An optical mixer 42A receives an input Eₙ=k₁E from splitter 24, and a modulating frequency ω_{A} from generator 28A. Mixer 42A is generally similar to shifter 26A, performing amplitude modulation on input Eₙ. However, unlike shifter 26A, an output from mixer 42A comprises an upper side-band q_{L}+ω and a lower side-band q_{L}−ω. Each side-band output may be represented in general as:

E_{carrier+}=k₃E₀ cos((q_{L}+nω)t), and

E_{carrier-}=k₄E₀ cos((q_{L}−nω)t) (4)

where k₃, k₄ are fractions between 0 and 1.

The output is preferably transferred via a splitter 58 to two narrow band-pass filters 46 and 48, which are respectively tuned to isolate the upper side-band and the lower side-band. Alternatively, other optical means known in the art for isolating the two side-bands are used. For example, the output from mixer 42A may be filtered to remove q_{L}, and the filtered output passed through a reflection/transmission filter which reflects one of the side-bands and transmits the other.

Each side-band is then used as a carrier which may be modulated, as described with reference to FIG. 1 for carriers output from respective shifters 26. Thus, upper side-band E_{carrier+} is input to an optical modulator 50, which receives a data stream S_{A+} from a data generator 54, and which generates a first data modulated output which may be represented as E=S_{A+}*E_{carrier+}. Similarly, lower side-band q_{L}−ω is input to an optical modulator 52, which receives a data stream S_{A-} from a data generator 56, and which generates a second data modulated output E=S_{A-}*E_{carrier-}. Modulators 50 and 52 are substantially similar in operation and implementation to modulators 32 described above. The outputs of modulators 50 and 56, together with outputs from modulators 32 and/or other modulators similar to modulators 50 and 56 and replacing modulators 32, is combined in multiplexer 34 for transmission to receiver 36, substantially as described above.

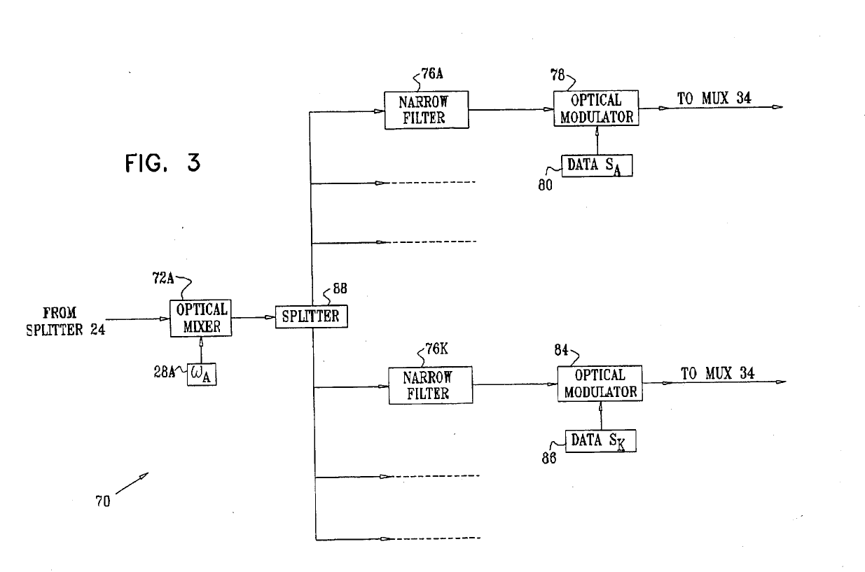

FIG. 3 is a schematic block diagram of a section 70 of another alternative carrier generation system, according to a preferred embodiment of the present invention. Section 70 replaces a shifter 26, and its related frequency generator 28, modulator 32, and data source 30 (FIG. 1). By way of example, section 70 is assumed to replace shifter 26A, frequency generator 28A, modulator 32A, and data source 30A, but it will be understood that similar replacements may be made for other shifters 26, related frequency generators 28, modulators 32, and data sources 30. Apart from the differences described below, the operation and construction of elements of section 70 indicated by the same reference numerals as elements of system 20 (FIG. 1) are generally similar.

An optical mixer 72A receives an input Eₙ=k₁E from splitter 24, and a modulating frequency ω_{A} from generator 28A Mixer 72A is generally similar to shifter 26A, performing amplitude modulation on input Eₙ. However, unlike shifter 26A, an output from mixer 72A comprises a multiplicity, i.e., more than two, of side-bands q_{L}+nω, where n is an integer. The multiplicity of side-bands may be produced by deep amplitude modulation of Eₙ, or by over-modulation of Eₙ, or by any other means known in the art for producing multiple side-bands from modulating frequency ω_{A}. The output of mixer 72A is preferably transferred via a splitter 88 to a respective number of narrow band-pass filters 76A, . . . 76K, . . . , which are respectively tuned to isolate each side-band. By way of example, FIG. 3 illustrates modulation of a first carrier from filter 76A by an optical modulator 78, and modulation of a second carrier from filter 76K by an optical modulator 84. However, it will be understood that the number of band-pass filters is determined by the number of harmonic carriers generated in mixer 72A.

Each side-band is then used as a carrier which may be modulated, substantially as described with reference to FIG. 1 for carriers output from respective shifters 26. The first carrier is modulated by data S_{A} from a data generator 80, to produce a first modulated carrier, and the second carrier is modulated by data S_{K} from a data generator 86, to produce a second modulated carrier. Modulators 78 and 84 are substantially similar in operation and implementation to modulators 32 described above. The outputs of modulators 78 and 84, together with outputs from modulators 32 and/or other modulators similar to modulators 78 and 84 and replacing modulators 32, are combined in multiplexer 34 for transmission to receiver 36, substantially as described above.

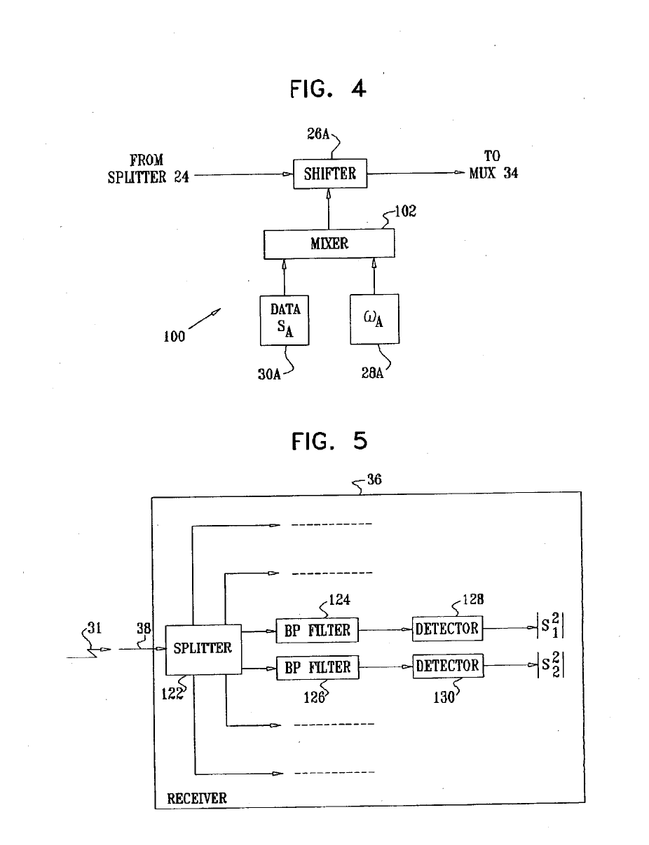

FIG. 4 is a schematic block diagram of a system 100 for generating a modulated carrier, according to a preferred embodiment of the present invention. System 100 may be used in place of any of the specific sets of components described above for producing a modulated carrier. By way of example, system 100 is assumed to replace the arrangement of shifter 26A, frequency generator 28A, modulator 32A, and data source 30A illustrated in FIG. 1. System 100 comprises a mixer 102, which receives data SA from data source 30A and single frequency ω_{A} generator 28A. The mixer generates a modulated output of frequency ω_{A} which may be represented as

E=S_{A}*k cos(ω_{A}t), (5)

where k is a constant proportional to an amplitude of the signal from generator 28A.

The modulated output from mixer 102 is then input to shifter 26A, which modulates its input signal from splitter 24 (proportional to E=E₀ cos(q_{L}t), equation (1)), and filters the output of the modulation so as to generate a signal having a specific ω_{A} and a specific source frequency q_{L}. The signal is of the form:

E=S_{A}*k cos(q_{L}+ω_{A}t) (6)

It will be appreciated that the signal from shifter 26A in system 100 is substantially similar to the signal from optical modulator 32A (FIG. 1), consisting of an optical carrier having a frequency q_{L}+ω_{A} which is modulated by data signal S_{A}. The signal from shifter 26A is then input to multplexer 34, substantially as described with reference to FIG. 1.

FIG. 5 is schematic block diagram of receiver 36, according to a preferred embodiment of the present invention. As described above with respect to FIG. 1, receiver 36 receives multiplexed output 31, preferably via optical fiber 38, and de-multiplexes and detects the output of the de-multiplexed signals. Output 31 is preferably transferred to a splitter 122, typically a passive fiber star splitter, which acts as an input port and which splits the output into a number of separate beams, the number corresponding to the number of modulated carriers comprised in output 31. Each beam is transferred, preferably by an optical fiber, or alternatively at least partly by other means such as over-the-air, to a narrow band-pass filter. By way of example two band-pass filters 124 and 126 comprised in receiver 36 are illustrated in FIG. 5. Each band-pass filter is tuned to one of the carrier frequencies generated in shifter 26 (FIGS. 1 and 4) mixer 42A (FIG. 2) or mixer 72A (FIG. 3). Preferably, each band-pass filter is implemented to be variably tuned, so that receiver 36 may alter the band passed by the filter if necessary. Alternatively, each band-pass filter is implemented to pass a substantially fixed band. Radiation from filters 124 and 126 are transferred respectively to detectors 128 and 130, which demodulate their respective signals to recover data S which was input in system 20.

Other methods for de-multiplexing output 31, and detecting signals comprised in the de-multiplexed carriers, will be apparent to those skilled in the art. For example, if band-pass filters 124 and 126 are tunable, they may be locked to a selected frequency. Most preferably, the locking is implemented by transmitting a portion of the output of source 22, E=E₀ cos(q_{L}t), and a portion of respective frequencies ω, or one or more references from which the respective frequencies ω and/or frequency q_{L} can be derived, in beam 31, as described above. The respective frequencies ω and frequency q_{L} are then used to generate respective carrier frequencies for filters 124 and 126, and the generated frequencies are used to lock the filters. All such de-multiplexing methods are assumed to be comprised within the scope of the present invention.

FIG. 6 is a graph of relative power in beam 31 vs. frequency, according to a preferred embodiment of the present invention. FIG. 6 illustrates a total of 22 carriers being transmitted in beam 31, the carriers being generated according to one or more of the systems described hereinabove. Frequency q_{L} of is radiation source 22 substantially equal to 2.00005*10⁵ GHz, and each of the carriers generated is separated by a frequency substantially equal to 1.5 GHz. It will be appreciated by those skilled in the art that carriers with these spacings are easily generated using carrier systems described herein, and that the spacing of the carriers is easily maintained.

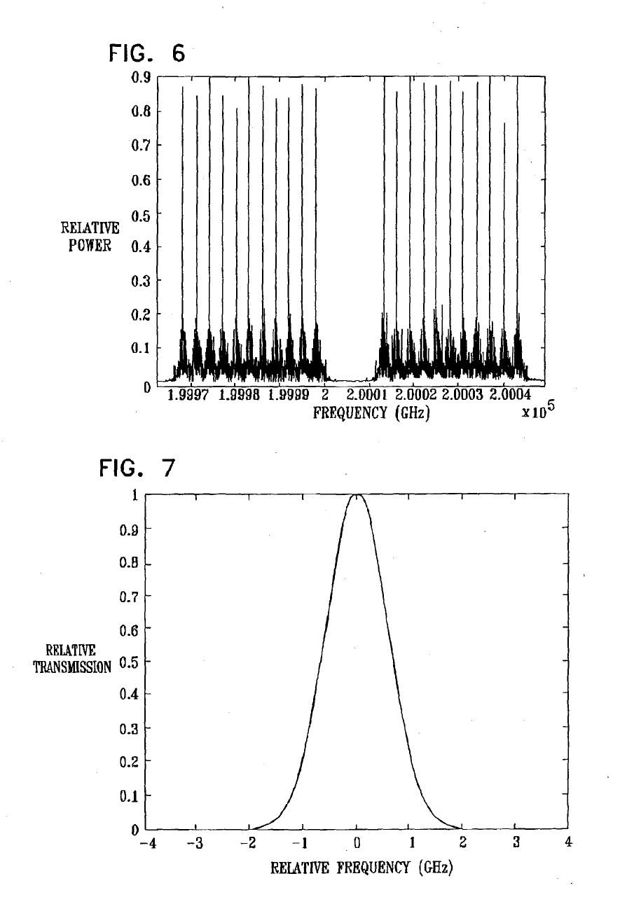

FIG. 7 is a graph of a frequency response of band-pass filters 124 and 126, according to a preferred embodiment of the present invention. As illustrated by the graph, filters 124 and 126 have a bandwidth approximately equal to 1.5 GHz, and so may be used to effectively isolate each of the carriers of beam 31 illustrated in FIG. 6. Filter frequency responses substantially similar to those of FIG. 7 are well known in the art, such responses being produced, for example, by narrow-band Fabry-Perot filters. It will be appreciated, however, that the scope of the present invention is not limited to any particular type of filter or filtration system in receiver 36. For example, carriers in receiver 36 may be separated by one or more relatively broadband Fabry-Perot filters followed by one or more etalon filters or grating filters.

FIG. 8 is a schematic block diagram of a multiple carrier generation system 150, according to a preferred embodiment of the present invention. A radiation source 152, substantially similar in implementation and operation as source 22 described above with reference to FIG. 1, generates an output which may be represented as:

E=E₀ cos(q_{L}t) (1)

This is input to a modulator 154. Modulator 154 comprises any form of phase or frequency modulator known in the art, such as a Mach-Zehnder modulator which is adapted to produce frequency modulation, or an electro-optic effect modulator. Modulator 154 is driven by one or more radio-frequency (RF) generators to perform the frequency modulation. Preferably, the generators output frequencies which are simple multiples of each other. Alternatively or additionally, at least some of the generators output frequencies which are not simple multiples of each other. Hereinbelow, by way of example, modulator 154 is assumed to be driven by a first radio-frequency (RF) generator 156 which generates a signal having a frequency ω, and a second RF generator 158 which generates a signal having a frequency nω, where n is a whole number>1. As described in the Background to the Invention, frequency modulation of E produces side-bands centered on q_{L}, and separated from q_{L} and each other by the modulating frequency.

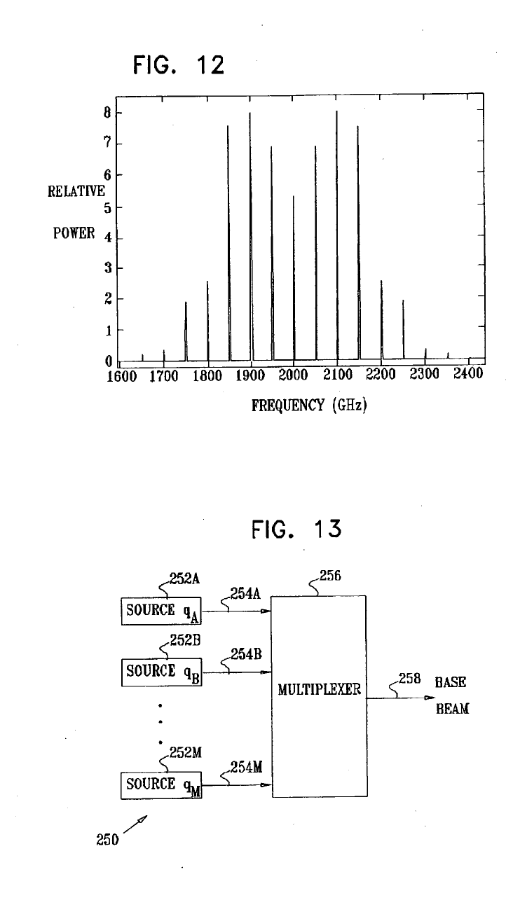

Most preferably, a level of generator 156 and the level of generator 158 are set so that levels of side-bands generated by modulator 154 are approximately equal. Alternatively or additionally, levels are approximately equalized by another method known in the art, such as selectively attenuating higher level side-bands. A more detailed description of level setting is given with respect to FIGS. 11 and 12 below.

The modulated output generated from modulator 154 is transferred to a de-multiplexer 160, which separates the side-bands into physically separate beams, each of which is used as a carrier. De-multiplexer 160 is preferably implemented substantially as described above for the initial stages of receiver 36. Alternatively, de-multiplexer 160 is implemented from a filter, such as a cascade of Fabry-Perot filters, or a Bragg filter or other diffractive element, or by any method known in the art for separating distinct side-bands.

Each carrier from de-multiplexer 160 may then be modulated with data, and the data transmitted as a modulated carrier, preferably as described above with reference to the carriers of system 20, wherein the modulated carriers are combined into a single beam before transmission to a receiver.

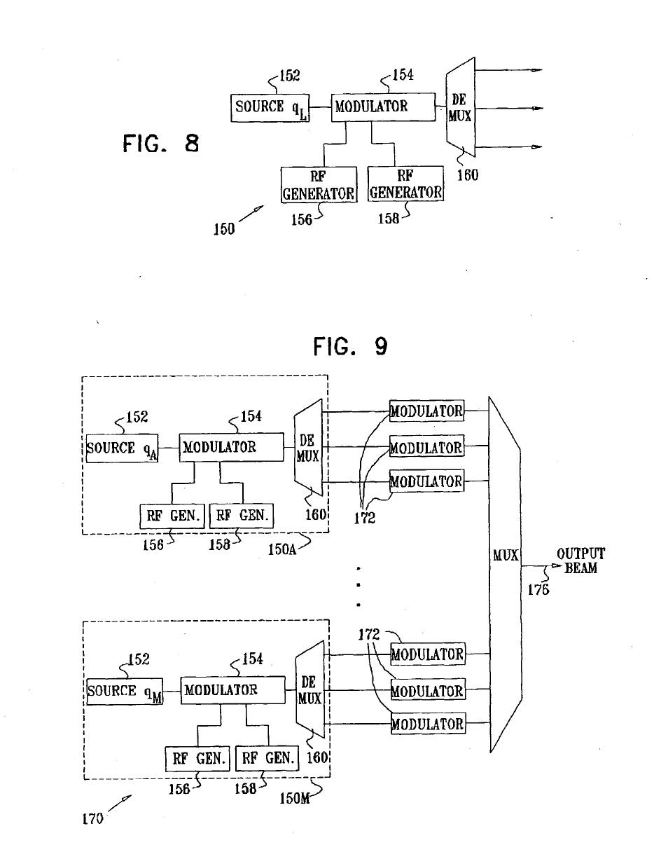

FIG. 9 is a schematic block diagram of an alternative multiple carrier generation system 170, according to a preferred embodiment of the present invention. Apart from the differences described below, the operation of system 170 is generally similar to that of system 150 (FIG. 8), so that elements indicated by the same reference numerals in both systems 150 and 170 are generally identical in construction and in operation. System 170 comprises two or more sets of systems 150A, . . . 150M, . . . each of the sets being implemented to be substantially similar to system 150. For clarity in FIG. 9 and the description hereinbelow, only systems 150A and 150M are specifically illustrated and described. It will be appreciated, however, that system 170 may comprise any number of similar systems 150 greater than one. Each system 150A, . . . 150M, . . . generates carriers substantially independently of each other. The frequency of the carriers of each of systems 150A, . . . 150M, . . . are most preferably set to be different by setting the frequency q_{L}, of each source 152 to be different. Preferably, the frequencies and levels of RF generators 156 and 158 are set to be substantially the same for each system 150A, . . . 150M, . . . . Alternatively, the frequencies or levels of RF generators 156 and 158 are set to be different for at least some of systems 150A, . . . 150M, . . . . Hereinbelow, by way of example, carriers from modulator 154 of system 150A are assumed to be separated by frequencies ω_{A}, and carriers from modulator 154 of system 150M are assumed to be separated by frequencies ω_{M}.

Source 152 comprised in system 150A is assumed to generate a frequency q_{A}, and source 152 comprised in system 150M is assumed to generate a frequency q_{M}, different from q_{A}. De-multiplexer 160 of system 150A generates a set of carriers based on q_{A}, and de-multiplexer 160 of system 150M generates a set of carriers based on q_{M}, substantially as described above for system 150. De-multiplexers 160 may implemented by any means known in the art, including, but not limited to, those methods of separation described hereinabove with respect to FIGS. 2, 3, 5, and 8, for separating optical beams into their respective constituent frequencies.

Each of the carriers from de-multiplexers 160 may then be modulated separately with data, in respective modulators 172, which are most preferably substantially similar in operation and implementation to modulators 32, described above with reference to system 20. Each of the sets of modulated carriers are then combined in a multiplexer 174, and the combined output beam of the multiplexer is transmitted, substantially as described above for output beam 31 of system 20, as an output beam 176.

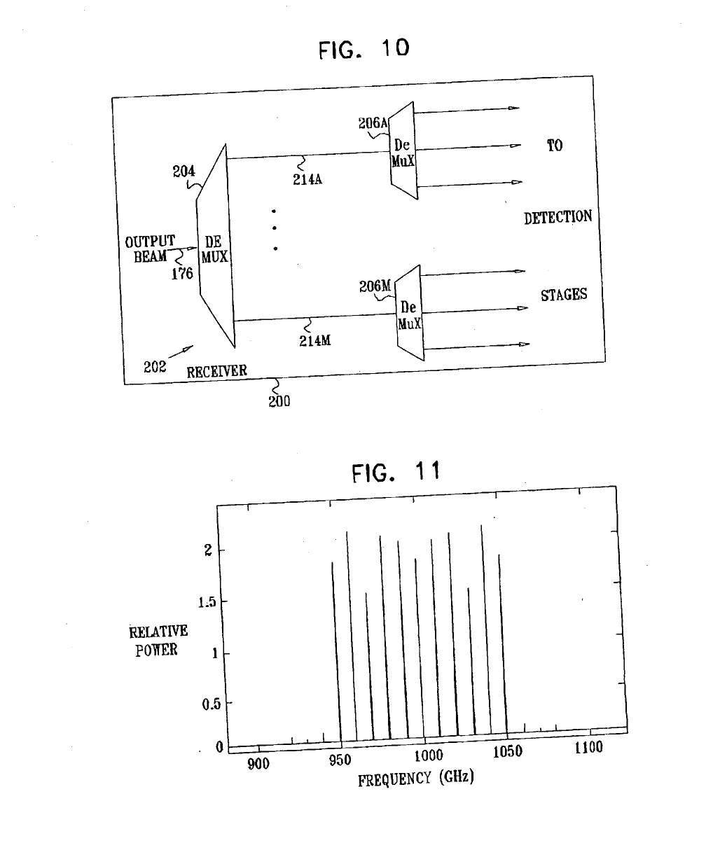

FIG. 10 is a schematic block diagram of an input section 202 of a receiver 200, according to a preferred embodiment of the present invention. Receiver 200 is adapted to receive output beam 176 (FIG. 9). Output beam 176 is received by a First de-multiplexer 204, which is implemented to separate beam 176 into separate sub-beams 214A, . . . 214M, . . . comprising respective sets of carriers based on the respective frequencies q_{A}, . . . q_{M}, . . . . For clarity, only sub-beams 214A and 214M are illustrated in FIG. 10. De-multiplexer 204 most preferably comprises a coarse de-multiplexer.

Each sub-beam 214A, . . . 214M, . . . is then de-multiplexed in respective, substantially similar, second de-multiplexer 206A, . . . 206M, . . . , which separate each of their respective incoming sub-beams into separate carriers. De-multiplexers 206A, . . . 206M, . . . most preferably comprise fine de-multiplexers. Data on each of the separate carriers is then recovered in a detection stage for each carrier, substantially as described for detection with respect to FIG. 5.

De-multiplexer 204 most preferably uses one or more carriers having frequencies q_{A}, q_{M}, . . . , or carrying references indicative of these frequencies, in order to implement its coarse separation of beam 176 . De-multiplexers 206A, . . . 206M, . . . most preferably use one or more carriers having frequencies ω_{A}, . . . ω_{M}, . . . , or carrying references indicative of these frequencies, in order to implement their respective fine separations of their respective incoming sub-beams.

De-multiplexers 204 and 206A, 206M,. may be implemented by any means known in the art, including, but not limited to, those methods of separation described hereinabove with respect to FIGS. 2, 3, 5, and 8, for separating optical beams into their respective constituent frequencies.

FIGS. 11 and 12 are graphs of power vs. frequency for the output of system 150 (FIG. 8), according to a preferred embodiment of the present invention. As is known in the art, an output of a frequency or phase modulated beam having frequency q_{L} may be represented as:

E=E₀ cos(q_{L}t+δ sin ωₘt) (7)

where E₀ is the amplitude of the beam,

ωₘ is a frequency of modulation, and

δ is a modulation index equal to

$$\frac{{ω}_{d}}{{ω}_{m}} ,$$

where ω_{d} is the maximum frequency deviation due to the modulation.

Equation (7) may be rewritten:

E=E₀[J₀(δ)cos q_{L}t+J₁(δ)cos(q_{L}+ωₘ)t−J₁(δ)cos(q_{L}−ωₘ)t)+J₂(δ)cos(q_{L}+2ωₘ)t+J₂(δ)cos(q_{L}−2ωm)t+ . . . ]. (8)

where Jₙ(δ) is a Bessel function of order n.

Equation (8) illustrates that the phase or frequency modulated beam comprises sets of side-bands separated from each other by ωₘ, each side-band having an amplitude E₀Jₙ(δ). Referring to the example described above with reference to FIG. 8, generator 156 generates a frequency of ωₘ, and generator 158 generates a frequency of 2ωₘ. Each generator forms sidebands according to equation (8), with appropriate changes due to the differing frequencies. Each side-band is formed as a sum of side-bands generated by both generators, and it will thus be appreciated that the resultant level of each side-band is a function of the level from generator 156 and from generator 158.

The graph of FIG. 11 shows relative power outputs from modulator 154, in the case when the modulator comprises a Mach-Zehnder modulator, when generator 156 operates at 10 GHz (ωₘ), and generator 158 operates at 20 GHz(2ωₘ). 1000 on the frequency axis corresponds to 193 THz (q_{L}). It will be appreciated that the side-band levels, and the level of q_{L} are all approximately equal.

The graph of FIG. 12 shows relative power outputs from modulator 154, in the case when the modulator comprises a phase modulator, when generator 156 operates at 50 GHz (ωₘ), and generator 158 operates at 100 GHz(2ωₘ). 2000 on the frequency axis corresponds to 193 THz (q_{L}). To generate the side-bands illustrated in FIGS. 11 and 12, a ratio of a level of generators 156 and 158 is set to be in a range lying between approximately 0.5 and approximately 3.0.

Referring back to FIG. 8, it will be appreciated that relative levels of side-bands may be adjusted to be approximately equal to each other by adjusting levels of generators, such as generator 156 and 158, and/or by altering the frequencies of the generators, and/or by altering the numbers of such generators. It will further be appreciated that the ratios of frequencies output by the generators may not necessarily be simple integer ratios.

It will also be understood that substantially any modulation scheme, using one or more generators such as generator 156 or 158 may be applied to modulator 154. Such modulation schemes include, but are not limited to, applying varying and/or discrete and/or continuous frequencies to modulator 154, or applying combinations of such types of frequencies.

FIG. 13 is a schematic block diagram illustrating a system 250 for generating a base optical beam, according to an alternative preferred embodiment of the present invention System 250 may be used instead of radiation source 22 (FIG. 1) or radiation source 152 (FIG. 8). System 250 comprises a plurality of separate sources, 252A, 252B, . . . , 252M, . . . which respectively generate base wavelengths q_{A}, q_{B}, . . . , q_{M}, . . . as respective beams 254A, 254B, . . . , 254M, . . . . At least some of sources 252A, 252B, . . . , 252M, . . . comprise a laser and/or an incoherent source followed by one or more filters. Beams 254A, 254B, . . . , 254M, . . . are received by a multiplexer 256, which combines the beams into a base output beam 258. Base beam 258 may then be used in the embodiments described above with reference to FIGS. 1-4, and FIGS. 8-10, mutatis mutandis, to generate “families” of side-bands of base wavelengths q_{A}, q_{B}, . . . , q_{M}, . . . .

It will be appreciated that preferred embodiments of the present invention facilitate the adding and/or dropping of carriers, since the carriers are generated electrically. For example, a carrier may be added to a set of initial carriers by adding a modulating frequency, or a component thereof, to the frequencies used to produce the initial carriers. Similarly, a carrier may be dropped from the set of initial carriers by removing a modulating frequency, or a component thereof, from the frequencies used to produce the initial carriers.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An optical transmitter, comprising:
a radiation source, which is adapted to generate a base optical beam with a base wavelength; and
at least one modulator, which is coupled to modulate the base optical beam so as to generate multiple carrier beams at respective side-bands of the base wavelength and to introduce information into the carrier beams for transmission thereby to a receiver.

2. A transmitter according to claim 1, wherein the radiation source comprises a single laser source.

3. A transmitter according to claim 1, wherein the radiation source comprises a broadband source and a filter which filters an output of the broadband source to generate the base wavelength.

4. A transmitter according to claim 1, wherein the at least one modulator comprises a side-band generator which is adapted to modulate the base optical beam by at least one modulation method chosen from a group of modulation methods comprising amplitude modulation, frequency modulation, and phase modulation.

5. A transmitter according to claim 4, and comprising an optical component which is adapted to divide the multiple carrier beams into separate sub-beams.

6. A transmitter according to claim 4, and comprising one or more radio-frequency (RF) generators which supply respective RF signals to the side-band generator.

7. A transmitter according to claim 6, wherein respective levels of the one or more RF generators are adjusted so that levels of the side-bands are substantially equal one to another.

8. A transmitter according to claim 1, wherein the at least one modulator comprises one or more components which separate the base optical beam into respective sub-beams, the one or more components comprising at least one of an optical splitter and a filter.

9. A transmitter according to claim 8, and comprising respective sub-beam modulators which modulate each of the sub-beams so as to generate the multiple carrier beams, each sub-beam modulator being adapted to modulate its respective sub-beam by at least one modulation method chosen from a group of modulation methods comprising amplitude modulation, frequency modulation, and phase modulation.

10. A transmitter according to claim 9, and comprising an RF generator, wherein at least one of the sub-beam modulators is adapted to receive the information and an RF signal from the RF generator and to generate its respective modulated sub-beam responsive to the information and the RF signal.

11. A transmitter according to claim 1, wherein the at least one modulator comprises respective data modulators which modulate each of the carrier beams with the information, and wherein at least one of the data modulators is adapted to perform its modulation by at least one modulation method chosen from a group of modulation methods comprising amplitude modulation, frequency modulation, phase modulation, and polarization modulation.

12. A transmitter according to claim 1, and comprising a multiplexer which combines each of the carrier beams comprising the introduced information into an output beam.

13. A transmitter according to claim 1, wherein the at least one modulator is coupled to introduce a reference into at least one of the carrier beams, the reference conveying at least one of a frequency of the base optical beam and a frequency of the multiple carrier beams.

14. An optical transmitter, comprising:
a plurality of radiation sources, each of which is adapted to generate a base optical beam with a different base wavelength; and
a plurality of modulators, each coupled respectively to one of the radiation sources, each of the modulators being coupled to modulate its respective base optical beam so as to generate respective multiple carrier beams at side-bands of the respective base wavelength and to introduce information into the carrier beams for transmission thereby to a receiver.

15. A method for optical communications, comprising:
generating a base optical beam at a base wavelength;
modulating the base optical beam so as to generate multiple carrier beams at respective side-bands of the base wavelength;
modulating the carrier beams with respective information signals; and
transmitting the modulated carrier beams to a receiver.

16. A method according to claim 15, wherein generating the base optical beam comprises generating the beam from a single laser source.

17. A method according to claim 15, generating the base optical beam comprises generating the beam from a broadband source and a filter which filters an output of the broadband source to generate the base wavelength.

18. A method according to claim 15, wherein modulating the base optical beam comprises modulating the beam by at least one modulation method chosen from a group of modulation methods comprising amplitude modulation, frequency modulation, and phase modulation.

19. A method according to claim 15, wherein modulating the base optical beam comprises dividing the multiple carrier beams into respective separate sub-beams.

20. A method according to claim 15, wherein modulating the carrier beams comprises performing the modulation by at least one modulation method chosen from a group of modulation methods comprising amplitude modulation, frequency modulation, phase modulation, and polarization modulation.

21. A method according to claim 15, wherein modulating the base optical beam comprises modulating the beam with one or more radio-frequency (RF) signals.

22. A method according to claim 21, wherein modulating the beam with one or more radio-frequency (RF) signals comprises adjusting respective levels of the one or more RF signals so that levels of the multiple carrier beams are substantially equal one to another.

23. A method according to claim 15, and comprising providing one or more components which separate the multiple carrier beams into respective sub-beams, the one or more components comprising at least one of an optical splitter and a filter.

24. A method according to claim 23, wherein modulating the base optical beam comprises modulating each of the sub-beams by at least one modulation method chosen from a group of modulation methods comprising amplitude modulation, frequency modulation, and phase modulation.

25. A method according to claim 15, and comprising combining each of the modulated carrier beams into an output beam.

26. A method according to claim 15, and comprising introducing a reference signal into at least one of the carrier beams, the reference signal conveying at least one of a frequency of the base optical beam and a frequency of the multiple carrier beams.

27. A method according to claim 15, and comprising:
separating each of the carriers at the receiver; and
demodulating each of the carriers so as to recover the respective information signals.

28. A method for generating a plurality of optical data carriers, comprising:
generating an optical beam having a base wavelength in a radiation source;
modulating the beam with at least one modulation frequency so as to generate a plurality of side-bands of the base wavelength; and
filtering the modulated beam so as to isolate each of the plurality of side-bands for use as an optical data carrier.

29. Apparatus for generating optical data carriers, comprising:
a radiation source which is adapted to generate an optical beam having a base wavelength;
an optical modulator which is adapted to modulate the beam so as to generate side-bands of the base wavelength; and
an optical filter which is adapted to isolate each of the side-bands for use as an optical data carrier.

30. Apparatus according to claim 29, wherein the radiation source comprises at least one source chosen from a group comprising a laser and a filtered broadband source.

31. Apparatus according to claim 29, wherein the optical modulator is coupled to perform the modulation by at least one method chosen from a group comprising amplitude modulation, phase modulation, and frequency modulation.

32. A method for generating a plurality of optical data carriers, comprising:
generating an optical beam having a base wavelength;
dividing the beam into a plurality of sub-beams at the base wavelength; and
modulating each of the sub-beams with a different, respective modulation frequency so as to generate one or more side-bands from each of the sub-beams.

33. Apparatus for generating optical data carriers, comprising:
a radiation source which is adapted to generate an optical beam having a base wavelength;
a splitter which is adapted to divide the beam into a plurality of sub-beams; and
a plurality of optical modulators each of which is adapted to receive a respective sub-beam and to modulate the sub-beam so as to generate one or more side-bands of the base wavelength.

34. A data receiver, comprising:
an input port which is adapted to receive a plurality of optical data carriers and a reference, the carriers having been generated by modulation of an optical beam having a base wavelength, each of the carriers being modulated by respective data, the reference characterizing at least one of a frequency of the base wavelength and the frequency of the modulation;
one or more filters which are adapted to separate each of the carriers responsive to the reference; and
a plurality of detectors each of which demodulates a respective carrier so as to recover the respective data present in the carrier.

35. An optical transmitter, comprising:
a radiation source, which is adapted to generate a base optical beam with a plurality of base wavelengths; and
at least one modulator, which is coupled to modulate the base optical beam so as to generate multiple carrier beams at respective side-bands of the plurality of base wavelengths and to introduce information into the carrier beams for transmission thereby to a receiver.

36. An optical transmitter according to claim 35, wherein the radiation source comprises:
a plurality of sources each of which is adapted to generate a different one of the plurality of base wavelengths; and
a multiplexer which combines the plurality of base wavelengths into the base optical beam.

37. A method for optical communications, comprising:
generating a base optical beam with a plurality of base wavelengths;
modulating the base optical beam so as to generate multiple carrier beams at respective side-bands of the plurality of base wavelengths;
modulating the carrier beams with respective information signals; and
transmitting the modulated carrier beams to a receiver.

38. A method according to claim 37, wherein generating the base optical beam comprises:
generating each of the plurality of base wavelengths with a respective source; and
combining the plurality of base wavelengths.
